(19) United States
(12) Patent Application Publication
(10) Pub. No.: US 2025/0117790 A1
(43) Pub. Date: Apr. 10, 2025

(54) SYSTEM AND METHOD FOR FACILITATING STREAMLINED COMMUNICATION BETWEEN SYSTEM COMPONENTS VIA DYNAMIC GENERATION OF UNIQUE IDENTIFIERS

(71) Applicant: JPMorgan Chase Bank, N.A., New York, NY (US)

(72) Inventors: Luis RIOS, Union, NJ (US); Hari Shankar KUPPA, Bangalore (IN); Awinash JADHAV, Princeton Junction, NJ (US); Vijay KUCHIBHOTLA, Glasgow (GB); Anupam BANSAL, Jersey City, NJ (US)

(73) Assignee: JPMorgan Chase Bank, N.A., New York, NY (US)

(21) Appl. No.: 18/515,907

(22) Filed: Nov. 21, 2023

(30) Foreign Application Priority Data
Oct. 5, 2023 (IN) 202311066895

(51) Int. Cl. G06Q 20/38; G06F 16/11

(52) U.S. Cl. CPC G06Q 20/389; G06F 16/116

(57) ABSTRACT

A method and system for generating a unique character string based on attribute information are disclosed. The method includes receiving transaction information of a non-standard transaction, extracting various attributes from the received transaction information, and dynamically generating a character string using a combination of the various attributes. The method further includes identifying a vendor identifier that corresponds with a set of attributes stored at a vendor device that matches with the various attributes of the dynamically generated character string, and consolidating the vendor identifier with the dynamically generated unique identifier for generating a unique consolidated identifier for the non-standard transaction.

### CROSS-REFERENCE TO RELATED APPLICATION

This application claims priority benefit from Indian application Ser. No. 202311066895, filed Oct. 5, 2023, which is hereby incorporated by reference in its entirety.

### TECHNICAL FIELD

This disclosure generally relates to data processing. More specifically, the present disclosure generally relates to facilitating streamlined communication between various system components via dynamic generation of unique identifiers.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Conventionally, a strategic data model may require all trade transactions on derivative contracts to be assigned a unique identifier, which may be generated from a system of record. The unique identifier may be used to represent a specific reference data object, which may be sent to downstream systems for various uses, such as positioning, regulatory reporting, risk and the like. A trade transaction capture system may be subject to such requirement. However, conventional trade transaction capture system has no direct connectivity to a central records identification system to obtain the unique identifiers. More specifically, there is no identifier currently available within the trade capture system that can be used to find the specific unique identifier that is associated to a contract that the trade transaction capture system has records on. As a result, the conventional trade transaction capture system does not have unique identifiers and post trade transaction activities cannot be facilitated by the downstream systems.

### SUMMARY

According to an aspect of the present disclosure, a method for generating a unique character string based on attribute information is provided. The method includes determining, by a processor, whether a transaction is a standard transaction that has a predefined identifier or a non-standard transaction that does not have a predefined identifier; when the transaction is determined to be the non-standard transaction: receiving, by the processor, transaction information of the non-standard transaction; extracting, by the processor, a plurality of attributes from the received transaction information; dynamically generating, by the processor, a character string using a combination of the plurality of attributes; identifying, by the processor, a vendor identifier that corresponds with a set of attributes stored at a vendor device that matches with the plurality of attributes of the dynamically generated character string; consolidating, by the processor, the vendor identifier with the dynamically generated character string for generating a unique consolidated identifier for the non-standard transaction; and storing, in a memory, the unique consolidated identifier and transmitting the unique consolidated identifier to one or more downstream applications.

According to another aspect of the present disclosure, the character string includes concatenated description of the plurality of attributes.

According to another aspect of the present disclosure, the method further includes when the transaction is determined to be the standard transaction, using the pre-defied identifier to identify the standard transaction; matching a vendor identifier corresponding to the pre-defined identifier; and consolidating, by the processor, the vendor identifier with the pre-defined identifier.

According to yet another aspect of the present disclosure, the standard transaction is a standard contract with a set of pre-defined fields.

According to another aspect of the present disclosure, the non-standard transaction is a non-standard contract including at least one unique value not found in the standard transaction.

According to a further aspect of the present disclosure, receiving, from a plurality of vendors and over a network, a plurality of vendor identifiers corresponding to a plurality of data records.

According to yet another aspect of the present disclosure, when the transaction is determined to be the standard transaction, transmitting the pre-defined identifier to the plurality of vendors.

According to a further aspect of the present disclosure, at least one of the plurality of vendor identifiers corresponds to the pre-defined identifier.

According to another aspect of the present disclosure, the consolidating includes establishing a relationship between the determined vendor identifier and the dynamically generated character string.

According to a further aspect of the present disclosure, the dynamically generated character string is used as a product code.

According to a further aspect of the present disclosure, each of the plurality of vendors uses a different vendor identifier to correspond to the pre-defined identifier.

According to an aspect of the present disclosure, a system for generating a unique character string based on attribute information is provided. The system includes a memory, a display and a processor. The system is configured to perform: determining whether a transaction is a standard transaction that has a predefined identifier or a non-standard transaction that does not have a predefined identifier; when the transaction is determined to be the non-standard transaction: receiving transaction information of the non-standard transaction; extracting a plurality of attributes from the received transaction information; dynamically generating a character string using a combination of the plurality of attributes; identifying a vendor identifier that corresponds with a set of attributes stored at a vendor device that matches with the plurality of attributes of the dynamically generated character string; consolidating the vendor identifier with the dynamically generated character string for generating a unique consolidated identifier for the non-standard transaction; and storing the unique consolidated identifier and transmitting the unique consolidated identifier to one or more downstream applications.

According to another aspect of the present disclosure, a non-transitory computer readable storage medium that stores a computer program for generating a unique character string based on attribute information is provided. The computer program, when executed by a processor, causes a system to perform multiple processes including: determining whether a transaction is a standard transaction that has a predefined identifier or a non-standard transaction that does not have a predefined identifier; when the transaction is determined to be the non-standard transaction: receiving transaction information of the non-standard transaction; extracting a plurality of attributes from the received transaction information; dynamically generating a character string using a combination of the plurality of attributes; identifying a vendor identifier that corresponds with a set of attributes stored at a vendor device that matches with the plurality of attributes of the dynamically generated character string; consolidating the vendor identifier with the dynamically generated character string for generating a unique consolidated identifier for the non-standard transaction; and storing the unique consolidated identifier and transmitting the unique consolidated identifier to one or more downstream applications.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a unique character string generation (UCSG) system in accordance with an exemplary embodiment.

FIG. 2 illustrates an exemplary diagram of a network environment with a UCSG system in accordance with an exemplary embodiment.

FIG. 3 illustrates a system diagram for implementing a UCSG system in accordance with an exemplary embodiment.

FIG. 4 illustrates a communication flow between a transaction capture system and a data object identification system.

FIG. 5 illustrates a method for facilitating streamlined communication between various system components via dynamic generation of unique identifiers in accordance with an exemplary embodiment.

FIG. 6 illustrates a system flow for facilitating streamlined communication between various system components via dynamic generation of unique identifiers in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

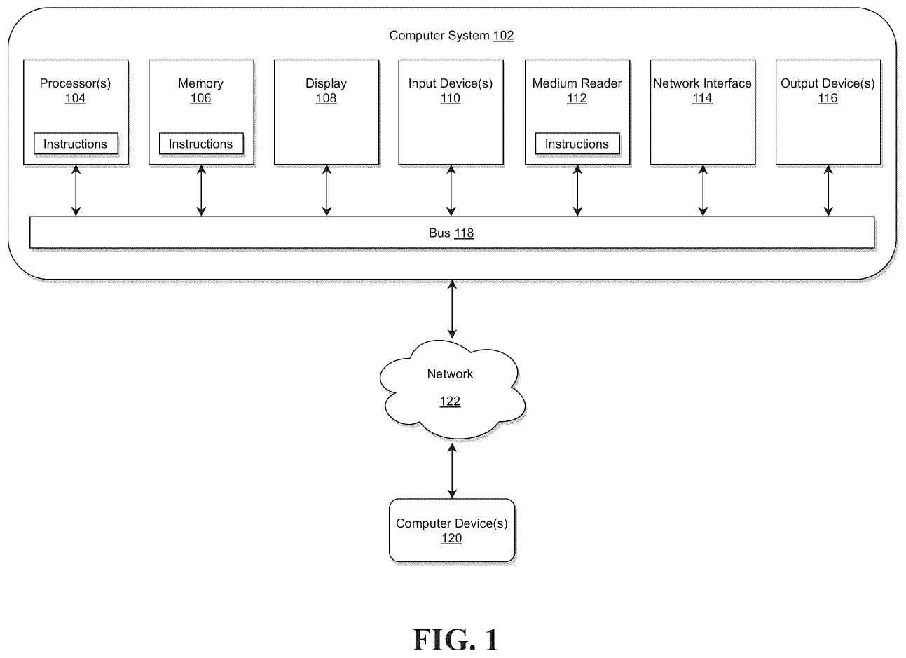

FIG. 1 illustrates a computer system for implementing a unique character string generation (UCSG) system in accordance with an exemplary embodiment.

The system 100 is generally shown and may include a computer system 102, which is generally indicated. The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The network interface 114 may include, without limitation, a communication circuit, a transmitter or a receiver. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an intemal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, or the like.

The computer system 102 may be in communication with one or more additional computer devices 120 via a network 122. The network 122 may be, but is not limited thereto, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in altemative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

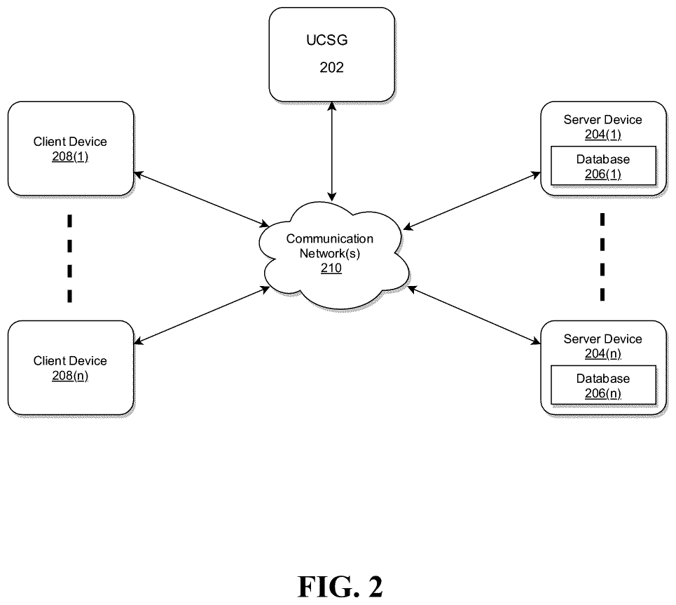

FIG. 2 illustrates an exemplary diagram of a network environment with a UCSG system in accordance with an exemplary embodiment.

UCSG system 202 may be implemented with one or more computer systems similar to the computer system 102 as described with respect to FIG. 1.

The UCSG system 202 may store one or more applications that can include executable instructions that, when executed by the UCSG system 202, cause the UCSG system 202 to perform actions, such as to execute, transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment or other networking environments. The application(s) may be executed within or as virtual machine(s) or virtual server(s) that may be managed in a cloud-based computing environment. Also, the application(s), and even the UCSG system 202 itself, may be located in virtual server(s) running in a cloud-based computing environment rather than being tied to one or more specific physical network computing devices. Also, the application(s) may be running in one or more virtual machines (VMs) executing on the UCSG system 202. Additionally, in one or more embodiments of this technology, virtual machine(s) running on the UCSG system 202 may be managed or supervised by a hypervisor.

In the network environment 200 of FIG. 2, the UCSG system 202 is coupled to a plurality of server devices 204(1)-204(n) that hosts a plurality of databases 206(1)-206(n), and also to a plurality of client devices 208(1)-208(n) via communication network(s) 210. According to exemplary aspects, databases 206(1)-206(n) may be configured to store data that relates to distributed ledgers, blockchains, user account identifiers, biller account identifiers, and payment provider identifiers. A communication interface of the UCSG system 202, such as the network interface 114 of the computer system 102 of FIG. 1, operatively couples and communicates between the UCSG system 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the UCSG system 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The UCSG system 202 may be a standalone device or integrated with one or more other devices or apparatuses, such as one or more of the server devices 204(1)-204(n), for example. In one particular example, the UCSG system 202 may be hosted by one of the server devices 204(1)-204(n), and other arrangements are also possible. Moreover, one or more of the devices of the UCSG system 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the UCSG system 202 via the communication network(s) 210 according to the HTTP-based protocol, for example, although other protocols may also be used. According to a further aspect of the present disclosure, in which the user interface may be a Hypertext Transfer Protocol (HTTP) web interface, but the disclosure is not limited thereto.

The server devices 204(1)-204(n) may be hardware or software or may represent a system with multiple servers in a pool, which may include internal or extemal networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the UCSG system 202 that may efficiently provide a platform for implementing a cloud native UCSG system module, but the disclosure is not limited thereto.

The client devices 208(1)-208(n) may run interface applications, such as standard web browsers or standalone client applications, which may provide an interface to communicate with the UCSG system 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the UCSG system 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the UCSG system 202, the server devices 204(1)-204(n), or the client devices 208(1)-208(n), for example, may be configured to operate as virtual instances on the same physical machine. For example, one or more of the UCSG system 202, the server devices 204(1)-204(n), or the client devices 208(1)-208(n) may operate on the same physical device rather than as separate devices communicating through communication network(s) 210. Additionally, there may be more or fewer UCSG system 202, server devices 204(1)-204(n), or client devices 208(1)-208(n) than illustrated in FIG. 2. According to exemplary embodiments, the UCSG system 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

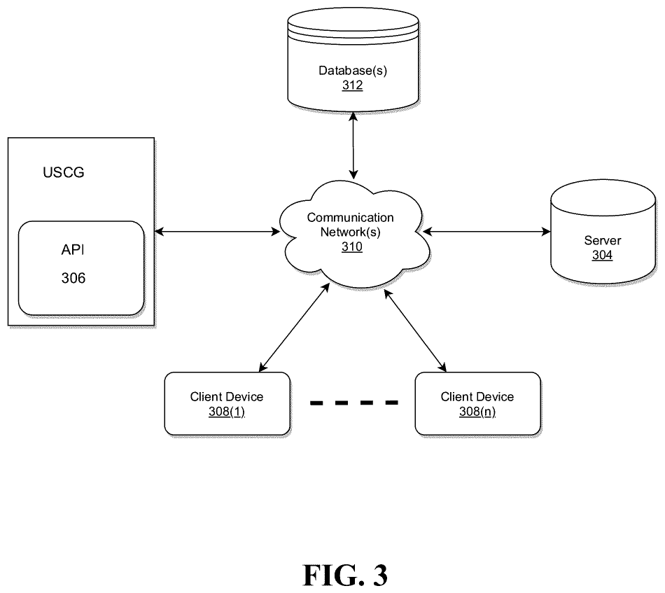

FIG. 3 illustrates a system diagram for implementing a UCSG system in accordance with an exemplary embodiment.

As illustrated in FIG. 3, the system 300 may include a UCSG system 302 within which a group of API modules 306 is embedded, a server 304, a database(s) 312, a plurality of client devices 308(1) . . . 308(n), and a communication network 310.

According to exemplary embodiments, the UCSG system 302 including the API modules 306 may be connected to the server 304, and the database(s) 312 via the communication network 310. Although there is only one database that has been illustrated, the disclosure is not limited thereto. Any number of databases may be utilized. The UCSG system 302 may also be connected to the plurality of client devices 308(1) . . . 308(n) via the communication network 310, but the disclosure is not limited thereto.

According to exemplary embodiment, the UCSG system 302 is described and shown in FIG. 3 as including the API modules 306, although it may include other rules, policies, modules, databases, or applications, for example. According to exemplary embodiments, the database(s) 312 may be embedded within the UCSG system 302. According to exemplary embodiments, the database(s) 312 may be configured to store configuration details data corresponding to a desired data to be fetched from one or more data sources, but the disclosure is not limited thereto.

According to exemplary embodiments, the API modules 306 may be configured to receive real-time feed of data or data at predetermined intervals from the plurality of client devices 308(1) . . . 308(n) via the communication network 310.

The API modules 306 may be configured to implement a user interface (UI) platform that is configured to enable UCSG system as a service for a desired data processing scheme. The UI platform may include an input interface layer and an output interface layer. The input interface layer may request preset input fields to be provided by a user in accordance with a selection of an automation template. The UI platform may receive user input, via the input interface layer, of configuration details data corresponding to desired data to be fetched from one or more data sources. The user may specify, for example, data sources, parameters, destinations, rules, and the like. The UI platform may further fetch the desired data from said one or more data sources based on the configuration details data to be utilized for the desired data processing scheme, automatically implement a transformation algorithm on the desired data corresponding to the configuration details data and the desired data processing scheme to output a transformed data in a predefined format, and transmit, via the output interface layer, the transformed data to downstream applications or systems.

The plurality of client devices 308(1) . . . 308(n) are illustrated as being in communication with the UCSG system 302. In this regard, the plurality of client devices 308(1) . . . 308(n) may be “clients” of the UCSG system 302 and are described herein as such. Nevertheless, it is to be known and understood that the plurality of client devices 308(1) . . . 308(n) need not necessarily be “clients” of the UCSG system 302, or any entity described in association therewith herein. Any additional or altemative relationship may exist between either or both of the plurality of client devices 308(1) . . . 308(n) and the UCSG system 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the UCSG system 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The UCSG system 302 may be the same or similar to the UCSG system 202 as described with respect to FIG. 2, including any features or combination of features described with respect thereto.

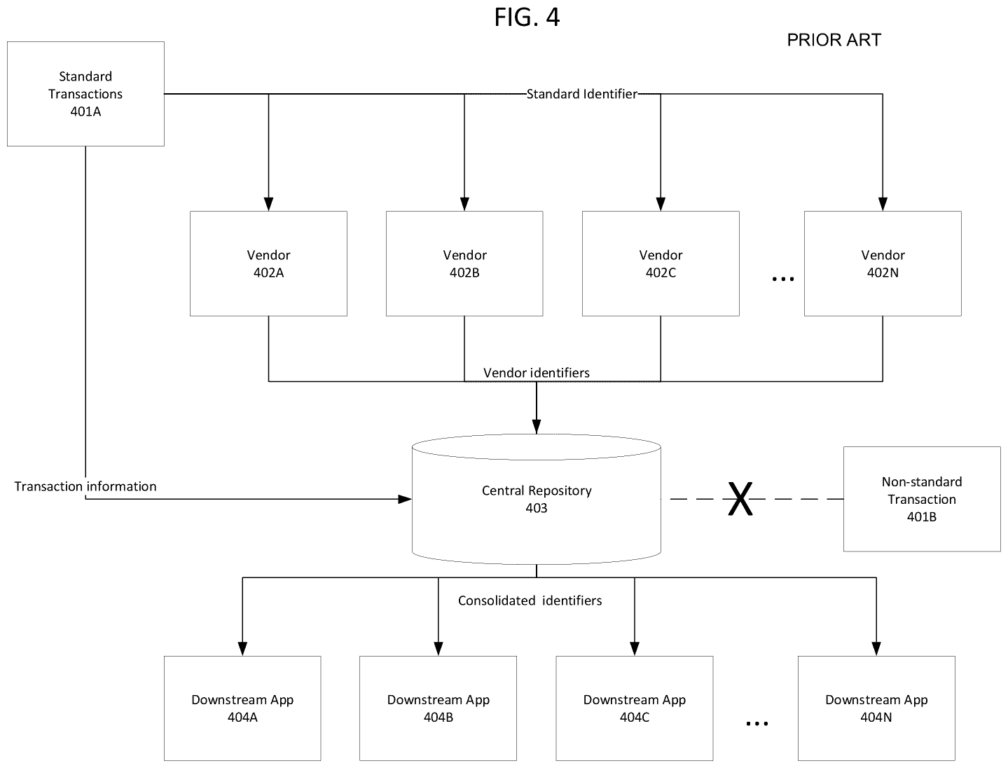

FIG. 4 illustrates a communication flow between a transaction capture system and a data object identification system.

As illustrated in FIG. 4, one or more standard transactions 401 A may transmit transaction information to a central repository 403. In an example, one or more standard transactions 401 A may include a standard contract, or other data transactions that may have predefined set of possible entries for processing. One or more standard transactions 401A may have standard identifiers that were previously agreed upon with various vendors, including vendor 402A, vendor 402B, vendor 402C and up to vendor 402N. Vendors may be external entities that may operate independently from other components illustrated in FIG. 4.

Further, one or more standard transactions 401A may also transmit transaction information or data of the respective transactions to a central repository 403 via an interface. Also, one or more vendor 402A, vendor 402B, vendor 402C up to vendor 402N may transmit vendor identifiers to the central repository 403 via an interface. At least since each of the listed vendors may be independently operated, they may utilize different identifiers to correspond to a particular standard transaction.

The central repository 403, in receipt of the transaction information from one or more standard transactions 401A and vendor identifiers from one or more vendor 402A, vendor 402B, vendor 402C up to vendor 402N, consolidate or combine the provided information to provide a unique consolidated identifier corresponding to a particular transaction, contract, product or data object.

Then the unique consolidated identifiers are then transmitted to one or more downstream application 404A, downstream application 404B, downstream application 404C up to downstream application 404N for performing various transactions and tying such transaction to the one or more standard transactions 401A.

Non-standard transactions 401B, unlike the standard transactions 401A, may have unique values that may not be uniform with standard transactions 401 A. Because some of the values may be unique that may not be predefined, the non-standard transactions 401B may not have predefined or standard identifiers that were previously agreed upon and distributed to vendors. Accordingly, when transaction information or attributes of the non-standard transactions 401B are transmitted to the central repository 403, the central repository 403 is unable to connect or combine information provided by the vendors (vendor 402A, vendor 402B, vendor 402C up to vendor 402N) with the transaction information or attributes of the non-standard transactions 401B. Accordingly, vendor information may be unable to be combined or consolidated with non-standard transactions 401B under a conventional system, and thus, no unique consolidated identifiers may be provided to any of the downstream applications (downstream application 404A, downstream application 404B, downstream application 404C up to downstream application 404N) for further processing.

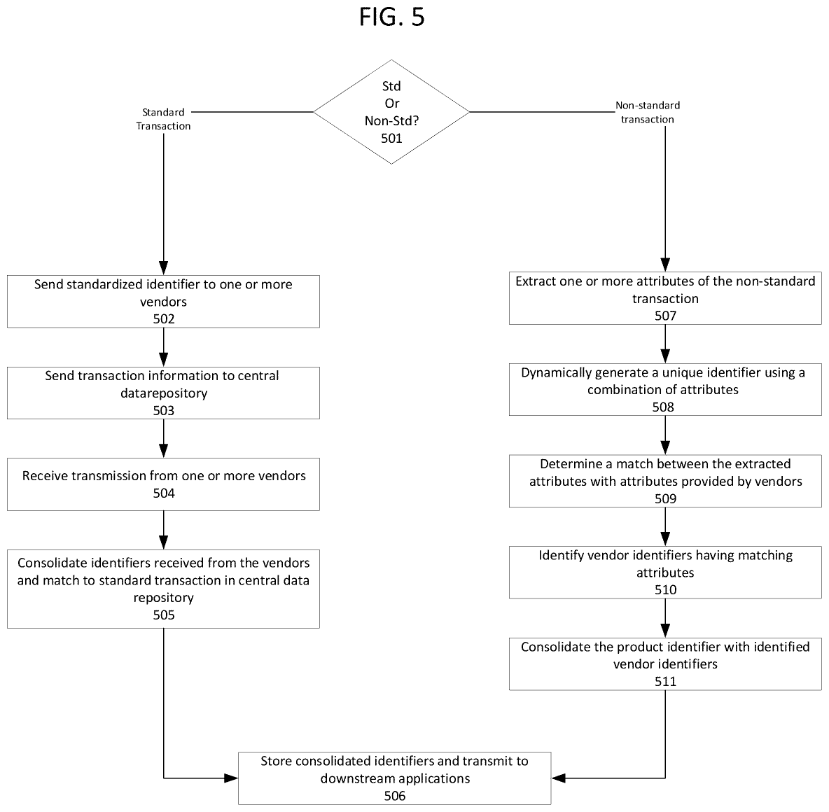

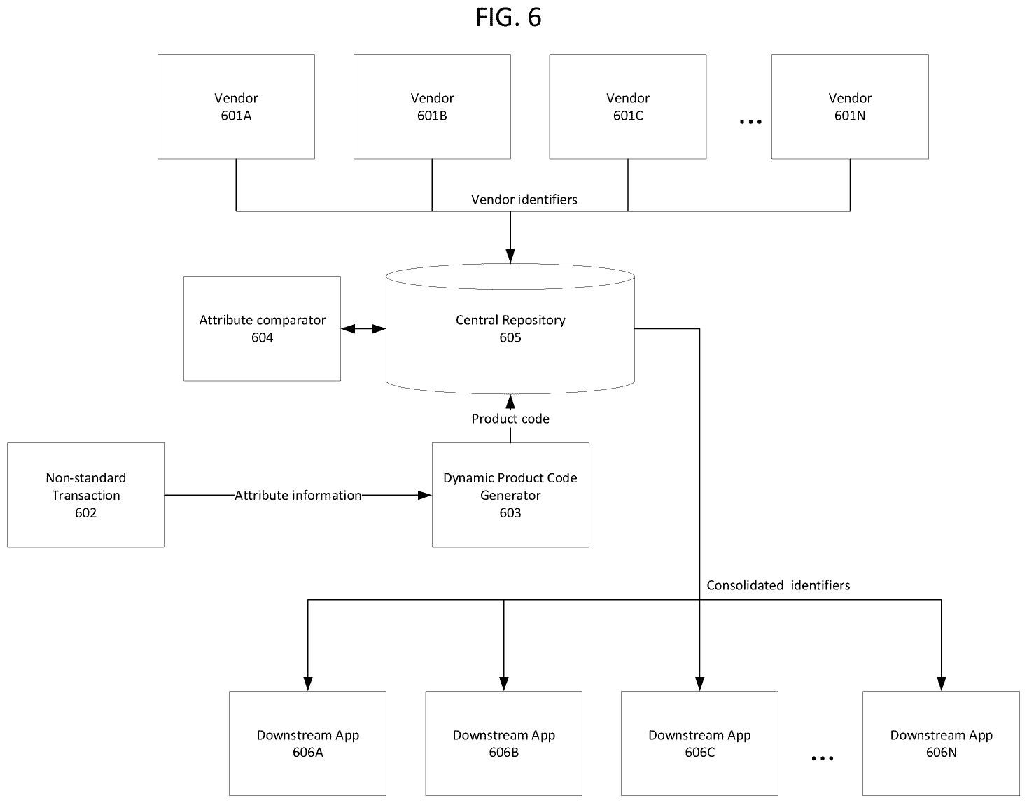

In view of such technical shortfall, a novel system architecture and method are exemplarily presented in FIG. 5 and FIG. 6 for resolving the above noted technical shortfall.

FIG. 5 illustrates a method for facilitating streamlined communication between various system components via dynamic generation of unique identifiers in accordance with an exemplary embodiment.

In operation 501, a transaction is received, and a determination of whether the received transaction is a standard transaction or a non-standard transaction. In an example, the received transaction may be a contract transaction, a data transaction, or other transactions. According to exemplary aspects, a standard transaction may have a standard or uniform field values (e.g., list of companies, countries and etc.) that may be selected or inputted and may have predefined or standardized identifiers that may be provided to one or more vendors and readily recognized by a central repository. On the other hand, a non-standard transaction may include one or more field values that are not standardized or uniform with other standard transactions. As such, a non-standard transaction may not have a predefined or standardized identifier that may be provided to a vendor beforehand or otherwise recognized by the central repository.

If the transaction is determined to be a standard transaction in operation 501, the method proceeds to operations 502, 503, 504, 505 and 506. On the other hand, if the transaction is determined to be a non-standard transaction in operation 501, the method proceeds to operations 507, 508, 509, 510, 511 and 506.

In operation 502, a standardized identifier assigned to the standard transaction is transmitted to one or more external vendors, such that vendors associate appropriate information or details to a proper transaction. According to exemplary aspects, each of the vendors may include the provided standard identifier along with other corresponding information and provide a unique identifier for the respective vendor.

In operation 503, transaction information of the standard transaction is transmitted to a central repository. The transaction information of the standard transaction may include values for a set of standardized data fields. In an example, the transaction information may refer to contract details, including, without limitation, intemational securities identification number, exercise style, contract size, settlement type and the like.

In operation 504, one or more of the vendors transmit vendor transaction information including the standardized identifier. According to exemplary aspects, extemal vendors may be utilized for performing specific operations corresponding to the transaction in question. At least since the external vendors operate independently from intemal systems of an organization, they may utilize identifiers that may be standard to a respective vendor, but unrecognizable by other parties. Accordingly, the vendors may utilize the standard identifier provided a standard transaction for subsequent identification by the organization.

In operation 505, the one or more identifiers received from one or more vendors and the transaction information of the standard transaction may be consolidated or combined to provide a single unique identifier corresponding to the respective standard transaction.

In operation 506, the unique identifier generated for the standard transaction is then stored in a central data repository and transmitted to one or more downstream applications for processing. At least since a single unique identifier is utilized for the standard transaction, the downstream application may work together to identify the correct transaction and attributes for performing downstream processing operations.

As noted above, for non-standard transactions, operations 507, 508, 509, 510, 511 and 506 may be performed.

In operation 507, one or more attributes may be extracted from the non-standard transaction. In an example, the one or more attributes may include, without limitation, contract size, settlement type, country code, international securities identification number, exercise style and the like.

In operation 508, a unique identifier is dynamically generated using a combination of attributes. More specifically, multiple attributes may be concatenated or otherwise modified and combined to create a specific character string that may indicate an association between the attributes. At least since the generated character string indicates an association between various attributes of the non-standard transaction, such a character string may provide descriptive information of the non-standard transaction, which is unavailable by random combination of letters and numbers that are typically utilized for generating an identifier. According to exemplary aspects, the non-standard transaction may be referred to as a product, and the specific character string may be referred to as a product code.

According to exemplary aspects, the specific character string may be generated using a rule-based algorithm or a machine learning (ML) or artificial intelligence (AL) algorithm or model. For example, a natural language processing (NLP) algorithm may be utilized to dynamically generate the unique identifier based on the attributes of the non-standard transaction. Further, the ML or AI algorithm or model may utilize or consider attribute field information stored at the vendors for identifying which attributes to utilize in the transaction information for generating the unique identifier or product code.

In an example, AI or ML algorithms may be generative, in that the AI or ML algorithms may be executed to perform data pattern detection, and to provide an output based on the data pattern detection. More specifically, an output may be provided based on a historical pattern of data, such that with more data or more recent data, more accurate outputs may be provided. Accordingly, the ML or AI models may be constantly updated after a predetermined number of runs or iterations are initially performed to provide initial training. According to exemplary aspects, machine learning may refer to computer algorithms that may improve automatically through use of data. Machine learning algorithms may build an initial model based on sample or training data, which may be iteratively improved upon as additional data are acquired.

More specifically, machine learning/artificial intelligence and pattern recognition may include supervised leaming algorithms such as, for example, k-medoids analysis, regression analysis, decision tree analysis, random forest analysis, k-nearest neighbors analysis, logistic regression analysis, N-fold cross-validation analysis, balanced class weight analysis, and the like. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, and the like.

In another exemplary embodiment, the ML or AI model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the ML or AI model may include training models such as, for example, a machine leaming model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the ML or AI models may be generated using at least one from among an artificial neural network technique, a decision tree technique, a support vector machines technique, a Bayesian network technique, and a genetic algorithms technique.

In operation 509, the dynamically generated unique identifier or product code may then be transmitted to the central repository for storage, and to determine a match between the attributes indicated in the unique identifier and attributes of various data records provided by the vendors.

In operation 510, once a match between attributes of a record provided by a vendor and the attributes indicated by the generated unique identifier, a vendor provided identifier is determined for the respective record having the matching attributes.

In operation 511, the dynamically generated identifier and the vendor identifier may then be consolidated or combined to generate a single unique consolidated identifier corresponding to the respective non-standard transaction. According to exemplary aspects, during the consolidation or the combination, a relationship between the dynamically generated identifier and the vendor identifier may be established.

In operation 506, the unique identifier generated for the non-standard transaction is then stored in a central data repository and transmitted to one or more downstream applications for processing. At least since a single unique identifier is utilized for the standard transaction, the downstream application may work together to identify the correct transaction and attributes for performing downstream processing operations.

FIG. 6 illustrates a system flow for facilitating streamlined communication between various system components via dynamic generation of unique identifiers in accordance with an exemplary embodiment.

System architecture as illustrated in FIG. 6 includes multiple vendors (vendor 601A, vender 601B, vendor 601C up to vendor 601N), a non-standard transaction 602, a dynamic product code generator 603, an attribute comparator 604, a central repository, and a set of down stream applications (downstream application 606A, downstream application 606B, downstream application 606C up to downstream application 606N).

According to exemplary aspects, the non-standard transaction 602 may transmit attribute information corresponding to a non-standard transaction. In an example, the non-standard transaction 602 may include a standard contract, financial contract/trade or other data transactions. Non-standard transactions 602, unlike a standard transaction, may have unique values that may not be uniform with standard transactions. Because some of the values may be unique that may not be predefined, the non-standard transactions may not have predefined or standard identifiers that were previously agreed upon and distributed to vendors. Accordingly, the non-standard transaction 602 may instead transmit attribute information to the dynamic product code generator 603 for generation of a unique identifier or character string prior to sending its underlying information to the central repository 605.

In an example, the dynamic product code generator 603 may be implemented by an interface executed by a processor, an integrated circuit. Further, the dynamic product code generator 603 may be integrated with the central repository 605 or separately implemented. According to exemplary aspects, the dynamic product code generator 603 may dynamically generate a unique identifier or character string using a combination of various attributes included in the attribute information corresponding to the non-standard transaction 602. More specifically, multiple attributes may be concatenated or otherwise modified and combined to create a specific character string that may indicate an association between the attributes. At least since the generated character string indicates an association between various attributes of the non-standard transaction, such a character string may provide descriptive information of the non-standard transaction, which is unavailable by random combination of letters and numbers that are typically utilized for generating an identifier. According to exemplary aspects, the non-standard transaction may be referred to as a product, and the specific character string may be referred to as a product code.

Once the dynamic product code generator 603 generates the product code for the non-standard transaction 602 by using its attribute information, the dynamic product code generator 603 transmits the product code to the central repository 605 for storage.

In an example, the attribute comparator 604 may be implemented by an interface executed by a processor, an integrated circuit. Further, the attribute comparator 604 may be integrated with the central repository 605 or separately implemented. According to exemplary aspects, the attribute comparator 604 identifies or extracts various attributes of the product code for the non-standard transaction 602, and then compares with stored attributes of vendor provided data records to identify a match. Each of the vendor 601A, vendor 601B, vendor 601C up to vendor 601N may provide vendor identifiers along with corresponding data records having various attributes.

Based on a match between the attributes of a vendor data record and attributes of the product code, the attribute comparator 604 may determine that the respective data record with the matching attributes corresponds to the product code and determines a vendor identifier of the respective data record of the vendor. Then, the attribute comparator 604 provides the determined vendor identifier to the central repository 605 as a matching identifier to the product code.

The central repository 605, in receipt of the product code corresponding to the non-standard transaction 602 and matching vendor identifier as determined by the attribute comparator 604, consolidate or combine the provided information to provide a unique consolidated identifier corresponding to the non-standard transaction 602. According to exemplary aspects, during the consolidation or the combination, a relationship between the dynamically generated identifier and the vendor identifier may be established.

Then the unique consolidated identifier is then transmitted to one or more downstream application 606A, downstream application 606B, downstream application 606C up to downstream application 606N for performing various transactions and tying such transaction to the non-standard transaction 602.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for generating a unique character string based on attribute information, the method comprising:
determining, by a processor, whether a transaction is a standard transaction that has a predefined identifier or a non-standard transaction that does not have a predefined identifier;
when the transaction is determined to be the non-standard transaction:
receiving, by the processor, transaction information of the non-standard transaction;
extracting, by the processor, a plurality of attributes from the received transaction information;
dynamically generating, by the processor, a character string using a combination of the plurality of attributes;
identifying, by the processor, a vendor identifier that corresponds with a set of attributes stored at a vendor device that matches with the plurality of attributes of the dynamically generated character string;
consolidating, by the processor, the vendor identifier with the dynamically generated character string for generating a unique consolidated identifier for the non-standard transaction; and
storing, in a memory, the unique consolidated identifier and transmitting the unique consolidated identifier to one or more downstream applications.

2. The method according to claim 1, wherein the character string includes concatenated description of the plurality of attributes.

3. The method according to claim 1, further comprising:
when the transaction is determined to be the standard transaction, using the pre-defied identifier to identify the standard transaction;
matching a vendor identifier corresponding to the pre-defined identifier; and
consolidating, by the processor, the vendor identifier with the pre-defined identifier.

4. The method according to claim 1, wherein the standard transaction is a standard contract with a set of pre-defined fields.

5. The method according to claim 1, wherein the non-standard transaction is a non-standard contract including at least one unique value not found in the standard transaction.

6. The method according to claim 1, further comprising:
receiving, from a plurality of vendors and over a network, a plurality of vendor identifiers corresponding to a plurality of data records.

7. The method according to claim 6, further comprising:
when the transaction is determined to be the standard transaction, transmitting the pre-defined identifier to the plurality of vendors.

8. The method according to claim 7, wherein at least one of the plurality of vendor identifiers corresponds to the pre-defined identifier.

9. The method according to claim 1, wherein the consolidating includes establishing a relationship between the determined vendor identifier and the dynamically generated character string.

10. The method according to claim 1, wherein the dynamically generated character string is used as a product code.

11. The method according to claim 8, wherein each of the plurality of vendors uses a different vendor identifier to correspond to the pre-defined identifier.

12. A system for generating a unique character string based on attribute information, the system comprising:
a memory; and
a processor,
wherein the system is configured to perform:
determining whether a transaction is a standard transaction that has a predefined identifier or a non-standard transaction that does not have a predefined identifier;
when the transaction is determined to be the non-standard transaction:
receiving transaction information of the non-standard transaction;
extracting a plurality of attributes from the received transaction information;
dynamically generating a character string using a combination of the plurality of attributes;
identifying a vendor identifier that corresponds with a set of attributes stored at a vendor device that matches with the plurality of attributes of the dynamically generated character string;
consolidating the vendor identifier with the dynamically generated character string for generating a unique consolidated identifier for the non-standard transaction; and
storing the unique consolidated identifier and transmitting the unique consolidated identifier to one or more downstream applications.

13. The system according to claim 12, wherein the character string includes concatenated description of the plurality of attributes.

14. The system according to claim 12, further comprising:
when the transaction is determined to be the standard transaction, using the pre-defied identifier to identify the standard transaction;
matching a vendor identifier corresponding to the pre-defined identifier; and
consolidating, by the processor, the vendor identifier with the pre-defined identifier.

15. The system according to claim 12, wherein the standard transaction is a standard contract with a set of pre-defined fields.

16. The system according to claim 12, wherein the non-standard transaction is a non-standard contract including at least one unique value not found in the standard transaction.

17. The system according to claim 12, further comprising:
receiving, from a plurality of vendors and over a network, a plurality of vendor identifiers corresponding to a plurality of data records.

18. The system according to claim 12, wherein the consolidating includes establishing a relationship between the determined vendor identifier and the dynamically generated character string.

19. The system according to claim 12, wherein the dynamically generated character string is used as a product code.

20. A non-transitory computer readable storage medium that stores a computer program for generating a unique character string based on attribute information, the computer program, when executed by a processor, causing a system to perform a plurality of processes comprising:
determining whether a transaction is a standard transaction that has a predefined identifier or a non-standard transaction that does not have a predefined identifier;
when the transaction is determined to be the non-standard transaction:
receiving transaction information of the non-standard transaction;
extracting a plurality of attributes from the received transaction information;
dynamically generating a character string using a combination of the plurality of attributes;
identifying a vendor identifier that corresponds with a set of attributes stored at a vendor device that matches with the plurality of attributes of the dynamically generated character string;
consolidating the vendor identifier with the dynamically generated character string for generating a unique consolidated identifier for the non-standard transaction; and
storing the unique consolidated identifier and transmitting the unique consolidated identifier to one or more downstream applications.
